(19) United States
(12) Patent Application Publication
(10) Pub. No.: US 2008/0055907 A1
(43) Pub. Date: Mar. 6, 2008

(54) Grid Screen for Illumination Devices

(76) Inventor: Attila Bruckner, Wasenbach (DE)

Correspondence Address: NORRIS, MCLAUGHLIN & MARCUS, 875 THIRD AVE, 18TH FLOOR, NEW YORK, NY, 10022, US

(21) Appl. No.: 11/539,988

(22) Filed: Oct. 10, 2006

(30) Foreign Application Priority Data
Sep. 5, 2006 (EP) 06076685.4

(51) Int. Cl. F21V 11/02

(52) U.S. Cl. 362/290

(57) ABSTRACT

In a grid screen for illumination devices, the honeycomb grid disc (5) is provided in the component (4) and is provided with a punched-out aperture (9). Fastening the grid screen is made possible by means of spring clips (10) which are in each case fixedly connected on both sides to the peripheral component (4) and whose cranked clip ends (11), which are directed towards the middle and rotated by 90°, reach through the punched-out middle aperture (9) of the honeycomb grid disc (5) and hook under the web (3) of the illumination device. Keyhole-type cutouts (8) on both sides at the aperture (9) are slipped over the web (3) in a contactless manner, the grid screen pressing onto the rim (7) of the reflector lamp (1) on account of the hooked-in spring clips (10). The deeply situated annular honeycomb grid disc (5) absorbs the glare rays (12) emerging underneath the cap (2), reflected useful rays (15) being passed through the honeycomb grid disc (5).

### BACKGROUND OF THE INVENTION

1. Field of the Invention

The invention relates to a grid screen for illumination devices comprising a honeycomb grid disc Grid screen for illumination devices, the illumination device comprising a reflector lamp including a web and a centrally arranged cap. The grid screen includes a peripheral component with an inserted honeycomb grid disc, lower and upper disc holders and grid screen fastening means.

2. Description of Related Art

Various grid screens are known which are attached directly on the luminous-body housing at a measured distance from the light source, in particular strip lights.

EP 0 819 232 B1 discloses an adapter for freely radiating miniature reflectors, in which a support element with light-directing components, for example ribs, is arranged on the reflector rim and is fastened underneath the reflector rim in an interlocking manner by means of clamping elements. This adapter is suitable for standardized illumination devices having a web and anti-glare caps only if the lower reflector rim is accessible and not obstructed. This solution is not suitable for relatively large illumination units.

According to DE 203 06 703 U1 there is known for an illumination device having a web and an anti-glare cap a fastening clamp which fastens a sheet-like body to the web by means of clamps. The sheet-like body is provided in its middle with a fastening means for filter discs. The interlocking and thus not sufficiently firm connection of the sheet-like body to the web of the illumination device is disadvantageous in this embodiment. The distance from the fastened filter to the light source and the anti-glare cap is such that light emerging at the sides underneath the anti-glare cap can dazzle the observer. The known embodiment according to EP 1 156 269 B1 has said disadvantage as well.

An illumination device is known according to DE 295 01 521 U1 in which an apparatus for fastening the filter disc is already arranged directly on the rim of the reflector. The peripheral component comprises non-elastic, but flexible material and is connected to the rim of the reflector in an interlocking manner. This component encloses the filter disc and spaces the disc apart from the light source. The interlocking fastening underneath the reflector ring by means of reflector holding claws is disadvantageous in this embodiment of the holding and spacer ring. In each case, the reflector claws need to be adapted corresponding to the formation of the lower rim of the reflector ring. In most known luminaires, the lower rim region is obstructed by further structural elements and no longer accessible for reflector claws. In principle, the disadvantage transpires that in reflector lamps without lower rims, or with only rudimentary lower rims or with covered lower rims, the reflector claws can only be adapted to the reflector ring with difficulty. Furthermore, loose fastening cannot be ruled out in the case of fastening by means of claws, and even lift-off of the reflector ring cannot be ruled out if a relatively strong force is applied. This known holding apparatus is suitable for holding honeycomb grid discs, but has the disadvantage that it cannot be applied in standardized illumination devices having a web projecting over the reflector rim and an anti-glare cap, because the cap and the web project beyond the rim of the reflector in these devices.

On account of their design, the fitted screens of the known illumination devices have the disadvantage of a relatively large distance to the luminous body, the result being that lateral emissions are not avoided. These lateral emissions have also not been eliminated with the known solutions for illumination devices having standardized webs and anti-glare caps. The rays emerging at the sides underneath the centrally arranged cap can emerge unimpeded underneath the screens.

### SUMMARY OF THE INVENTION

The object of the invention is to provide a secure holding means of the honeycomb grid disc and a fastening means of the grid screen for a plurality of standardized illumination devices, which fastening means is connected to the rim of the reflector lamp in a force-fitting manner and simultaneously holds a honeycomb disc in an interlocking manner, and wherein the grid screen is at the same time designed such that arrangement of the honeycomb grid disc is possible despite a highly situated web, and thus disturbing lateral emissions are reduced or completely avoided.

The invention is particularly suitable for all reflector lamps with standardized rim formation, such as the aluminium reflector lamp 111 mm. The only measurement for the adaptation is the diameter of the upper reflector rim.

This object is achieved according to the invention by means of the features of the patent claim, that is to say that the honeycomb grid disc of the grid screen is provided with a punched-out aperture and the grid screen fastening means comprises spring clips which are fixedly connected on both sides in each case by one side to the peripheral component and whose cranked clip ends, which are directed towards the middle, reach through the punched-out middle aperture of the honeycomb grid disc and hook under the web of the illumination device, and the grid screen presses onto the rim of the reflector lamp, wherein the keyhole-type cutouts on both sides are arranged slipped over the web such that the deeply situated honeycomb grid disc absorbs the scattered light emerging from the sides underneath the cap.

### BRIEF DESCRIPTION OF THE DRAWING

An exemplary embodiment of the invention will be explained in detail with reference to the drawings.

In the drawings:

FIG. 1 shows the illustration of a standardized illumination device,

FIG. 2 shows the grid screen in the assembled complex,

FIG. 3 shows the grid screen in an exploded view, and

FIG. 4 shows a sketch of the prevented lateral emission.

### DETAILED DESCRIPTION OF THE INVENTION

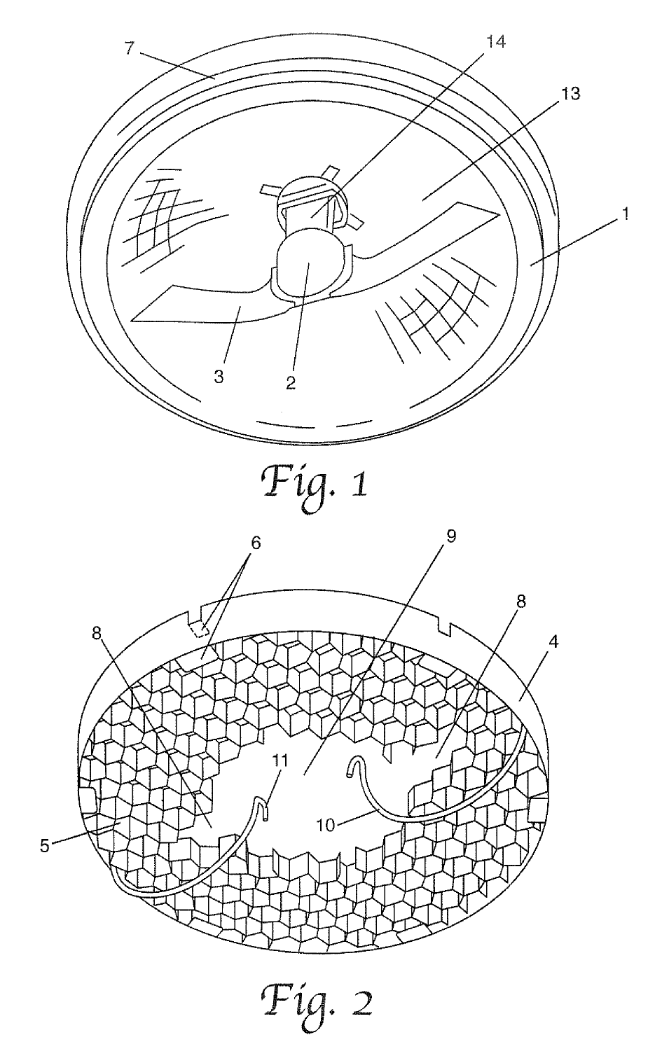

According to FIG. 1, the known illumination unit comprises a reflector lamp 1 having a web 3 fixedly arranged on the reflector 13. An anti-glare cap 2 is fastened centrally on the web 3. The upper portion of the light source 14 projects into the cap 2. The outer upper rim 7 of the reflector lamp 1 is standardized in terms of structural dimensions and classifications, as are the web 3 and the cap 2. The upper rim 7 of the reflector lamp 1 forms an annular step-like shoulder which also projects out of the structure when the reflector lamp 1 is installed.

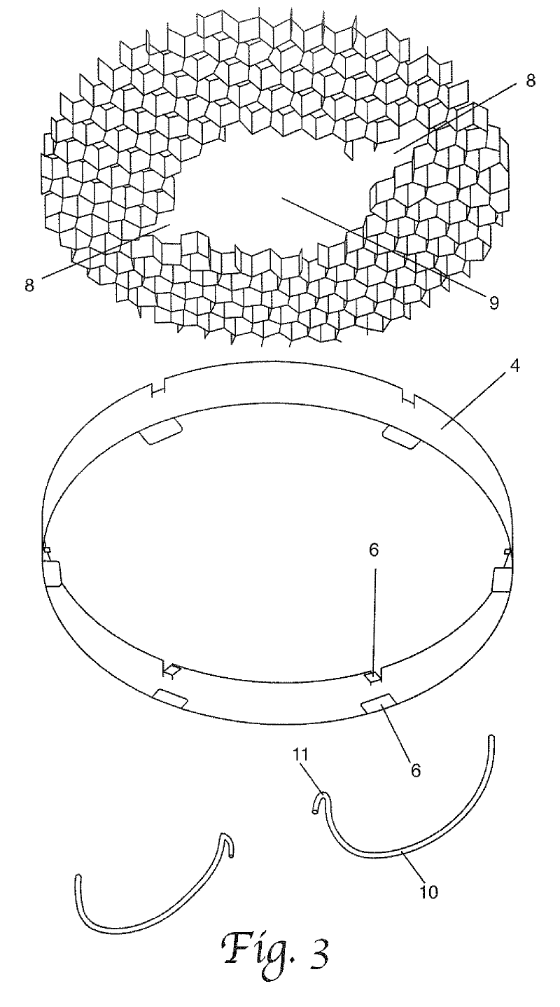

The grid screen according to FIGS. 2, 3 and 4 comprises a peripheral component 4 having upper and lower disc holders 6. In the angled-away state, the disc holders 6 space apart a honeycomb grid disc 5 inserted therebetween. Spring clips 10 for fastening the grid screen are provided on the periphery of the component 4. The spring clips 10 are fixedly attached to the peripheral component 4 and are cranked towards the middle as clip ends 11 and rotated by 90°. The fixed arrangement of the spring clips 10 on the component 4 is effected advantageously by spot-welding. For this purpose, the ends of the spring clips 10 are formed into lugs (not illustrated in the drawing). A centric aperture 9 having keyhole-type cutouts 8 at the sides is punched out in the honeycomb grid disc 5. The grid screen is formed as an inherently compact device in the mounted state.

Only the dimensions of the diameter of the step-like rim 7 need to be adhered to in the formation of the component 4 in order to form a finished unit with the customary reflector lamp 1. The aperture 9, the keyhole-type cutouts 8 and the spring clips 10 have diameter-dependent measurements and can be prefabricated completely for any desired diameters of the reflector lamps 1.

The grid screen adapted to the diameter of the reflector lamp 1 is fitted on the step-like rim 7 of the reflector lamp 1 and fastened in a manner such that the keyhole-type cutouts 8 of the honeycomb grid disc 5 are in each case slipped over the web 3 and the web 3 thus projects into the honeycomb grid disc 5. The spring clips 10 projecting into the punched-out aperture 9 are manually hooked under the web 3 of the reflector lamp 1 by their cranked clip ends 11. This completes the mounting of the grid screen. The grid screen is connected to the reflector lamp 1 by means of the spring clips 10 in a force-fitting manner and the honeycomb grid disc 5 is connected to the component 4 by means of the upper and lower disc holders 6 in an interlocking manner.

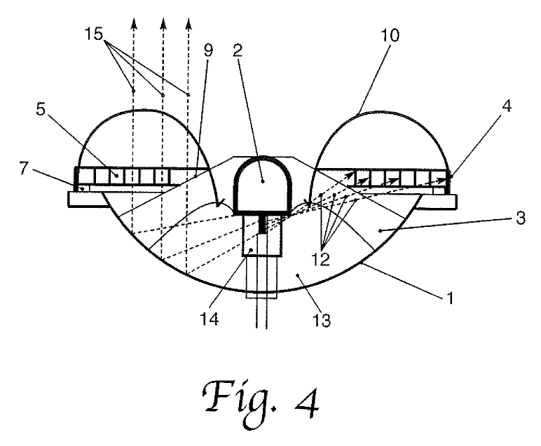

According to FIG. 4, the disturbing glare rays 12, which are present underneath the cap 2 at the sides, from the light source 14 are absorbed by the honeycomb grid disc 5, while the reflected useful rays 15 are passed through the honeycomb grid disc 5.

The grid screen is advantageous because it rules out disturbing glare lateral, is in the form of, and available as, a compactly prefabricated retrofit part, can be mounted and dismounted easily, and is connected to the reflector lamp 1 in a force-fitting manner such that a spacing from articles is additionally achieved by means of the projecting spring clips 10, and thus the risk of overheating given too small a spacing is reduced, only one connection parameter sufficing in order to be fastened to the standardized reflector lamps in the prefabricated state. The compact grid screen is advantageously in the form of a light-weight unit on account of few components being used.

What is claimed is:

1. A grid screen for an illumination device, the illumination device including a reflector lamp (1) having a web (3) and the centrally arranged cap (2), the grid screen comprises a peripheral component (4) with inserted honeycomb grid disc (5), lower and upper disc holders (6) and a grid screen fastening means, wherein the honeycomb grid disc (5), arranged in the peripheral component (4) of the grid screen is provided with a punched-out aperture (9) and the grid screen fastening means comprises spring clips (10) which are in each case fixedly connected on both sides to the peripheral component (4) having cranked clip ends (11), directed towards the middle and rotated by 90°, reach through the punched-out middle aperture (9) of the honeycomb grid disc (5) and hook under the web (3) of the illumination device, and keyhole-type cutouts (8) on both sides are arranged over the web (3) in a contactless manner and the grid screen presses onto a rim (7) of the reflector lamp (1), and the deeply situated annular honeycomb grid disc (5) absorbs the glare rays (12) emerging underneath the cap (2), reflected useful rays (15) being passed through the honeycomb grid disc (5).

2. Grid screen according to claim 1, wherein the spring clips (10) are in the form of a lug at one end and are fastened on the component (4) by spot-welding.

3. Grid screen according to claims 1, wherein the spring clips (10) are flat steel spring clips.
